(19) United States
(12) Patent Application Publication
(10) Pub. No.: US 2008/0278138 A1
(43) Pub. Date: Nov. 13, 2008

(54) High accuracy constant-off average output current control scheme

(76) Inventor: Qi Cui Wei, Cupertino, CA (US)

Correspondence Address: Qi Cui Wei, 21900 Rucker Dr., Cupertino, CA, 95014, US

(21) Appl. No.: 12/003,498

(22) Filed: Dec. 26, 2007

(30) Foreign Application Priority Data
May 8, 2007 (CN) 200710068436.4

(51) Int. Cl. H02J 1/00

(52) U.S. Cl. 323/318

(57) ABSTRACT

A high accuracy constant-off average output current control is provided. It is composed of the reference block generates preset reference and converts the reference signal into a suitable format; the state detecting block, the state variables of switching power converter are detected and the detected signals are converted into the same signal format as one of output from reference block; The error-zero detector is used to detect the error between the outputs from reference block and state detected block and trigger constant off timer as the error is cross over zero; the constant off timer, the constant off time is dependent on the input and output voltages of the switching converter. Four function blocks can be simple as comprising of a basic operation and be implemented with several operation functions. The present invention can make the accuracy of the switching converter's output average current independent of the input and output voltages of the switching converter and accuracy of circuit devices and constant off time and in the simplest and lowest cost to implement the average current control of step-down switching converter.

### BACKGROUND OF THE INVENTION

The present invention relates to step-down switching converter topology. More particularly, the invention relates to a new high accuracy control scheme to control the output current of the step-down switching converter, and the switching converter can be used as a controllable current source for several applications.

In existed switching converter control schemes, there is constant off control scheme. It uses to generate a series of PWM pulses and to control the power switch in the switching converter. It can make the output average current following the preset reference signal. The control scheme is simpler and doesn't need additional compensation circuit. But the accuracy of the control scheme is largely dependent on the input and output voltage of the switching converter, accuracy of circuit devices and constant off time. In lower accuracy output application, the control scheme has been widely used. To increase control accuracy is a key point to extend constant off control application area.

### SUMMARY OF THE INVENTION

The present invention discloses a novel “High Accuracy Constant-Off Average Output Current Control” scheme to control a switching converter and make the average output current accuracy independent of the input and output voltages of the switching converter and accuracy of circuit devices and constant off time.

The control scheme is composed of several blocks. The reference block generates preset reference and converts the reference signal into a suitable format; In state detecting block, the states of switching power converter are detected and the detected signals are converted into the same signal format as one of output from reference block; The error-zero detector is used to detect the error between the outputs from reference block and state detected block and trigger constant off timer as the error is cross over zero; In the constant off timer, the constant off time is dependent on the input and output voltages of the switching converter.

The error-zero detector can be simple as comprising of a basic operation and be implemented with several operation functions. The state detect block can be simple as a sense resistor and be implemented with several operation functions. The reference block can be simple as comprising of a basic operation and be implemented with several operation functions. The controllable constant off timer block can be simple as comprising of a basic operation and be implemented with several operation functions.

The invented control scheme is composed of several function blocks. As shown in FIG. 2, they are reference block, state detecting block, error-zero detecting block and controllable constant off timer block.

In order to compare the reference current and the average output current, during the power switch turn-on, the output V_{L} from state detecting block and the output V_{REF} from the reference block are compared and detected in the error-zero detector block. As the output from error-zero detector is zero, the power switch of the switching converter is turned off and the controllable constant off timer is triggered. The power switch is off for constant off time T_{OFF} and after then the power switch turns on again.

The invented control scheme uses all information in a part of the inductor current, including slew rate, valley and peak values and instant average current. The easiest way to detect part of the inductor current is to detect the power switching current during the power switch turn-on. For a high frequency triangle inductor current waveform, the average current is equal to the instantaneous average current of the power switch during turn-on interval. The present invention control scheme is to control the instantaneous average current during the power switch turn-on and to control the output average current of the switching converter.

In the present invention control scheme, the instantaneous average current of partial inductor current is directly compared with the preset reference signal V_{REF} and the instantaneous average current is controlled to follow the preset control signal. The present invention control scheme makes the average output current accuracy independent of the input and output voltages of the switching converter and accuracy of circuit devices and constant off time.

### BRIEF DESCRIPTION OF THE DRAWINGS

FIG. 1 is an existed constant off control scheme for step-down converter output current control;

FIG. 2 is the present invention average output current control scheme block diagram for step down switching converter;

FIG. 3 is one of detailed embodiment of the “High Accuracy Constant-Off Average Output Current Control” scheme block diagram;

FIG. 4 is one timing diagram of embodiment of FIG. 3 (CH1=inductor current; CH2=the output of reset able integrator; CH3=output PWM control signal)

FIG. 5 is another of detailed embodiment of the “High Accuracy Constant-Off Average Output Current Control” scheme block diagram.

### DETAIL DESCRIPTION OF THE INVENTION

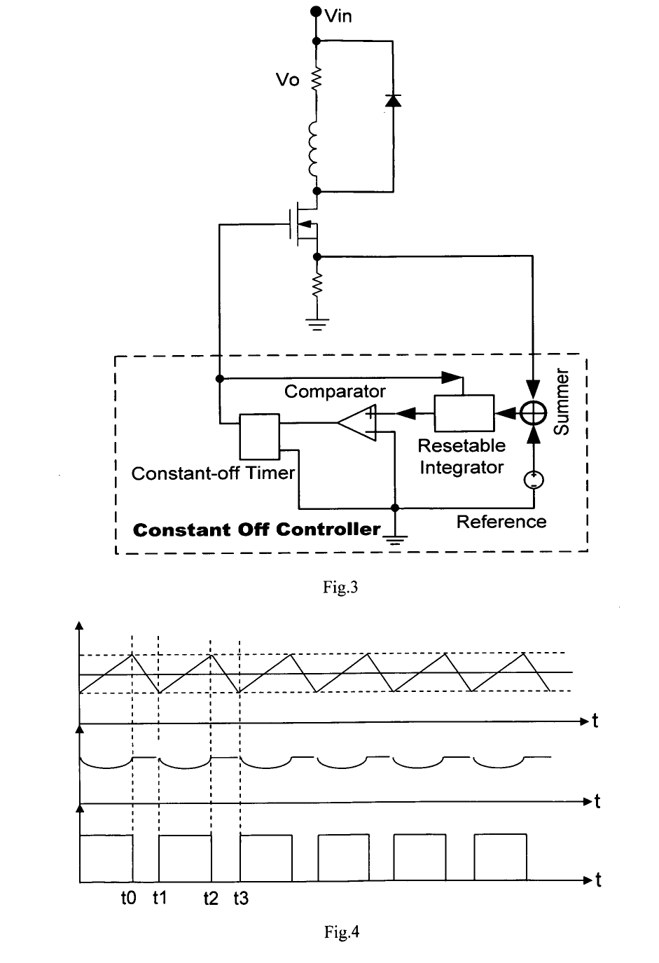

FIG. 3 shows one detailed embodiment of invention scheme block diagram. In the detailed block diagram, there are several blocks: preset reference control signal, summer, resetable integrator, comparator and constant off timer.

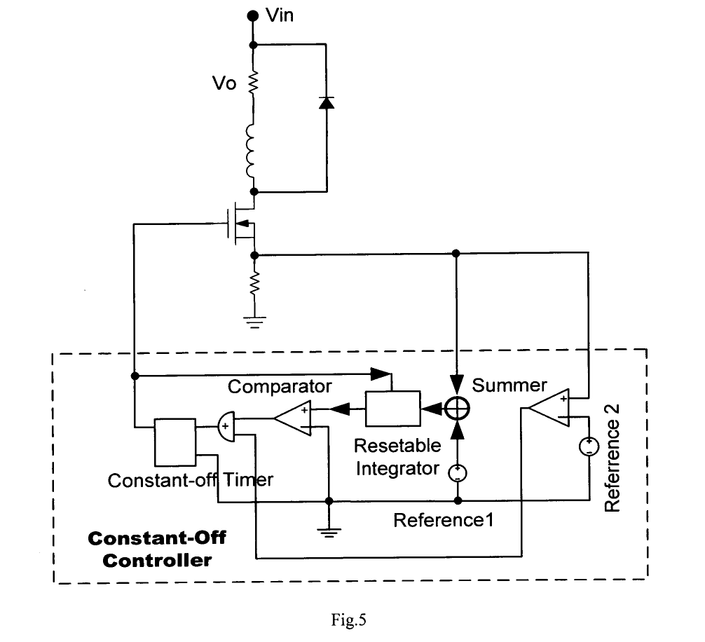

As power switch turns on, the inductor current increases. The inductor current is detected as a sense voltage on the sense resistor. The sense voltage subtracts with the preset control signal in summer. The output of the summer is used as the input of the resetable integrator. The output of resetable integrator is shown in FIG. 4. With the increase of the inductor current, the output of resetable integrator is changed from zero to negative and from negative to zero. As the output of resetable integrator increases from negative to zero, the comparator takes action to trigger constant off timer. The output of the constant off timer resets the resetable integrator and makes the power switch turn off. The power switch is turn-off for a fixed constant off interval. After the constant off interval, the power switch turns on again and repeats in the switching cycle. As the output of resetable integrator changes from negative to zero, the instantaneous average inductor current is equal to the preset control signal and the power switch is turned off.

The summer and resetable integrator are simpler circuit. Due to the characteristic of resetable integrator and the difference between the average and peak current, FIG. 5 shows a mixed control scheme. It combines control schemes shown in FIG. 1 and FIG. 3. In the control scheme, the control scheme in FIG. 1 is used to control dynamic current, that is, to limit the peak current; the control scheme in FIG. 3 is used to control steady state current, that is, average output current. Due to the combination function of FIG. 1 and FIG. 3, the dynamic current can convergence to the steady state current quickly.

The switching frequency of switching converter with constant off control scheme is variable with the input and output voltage of the switching converter. In order to make the switching frequency almost constant, the constant off time T_{OFF} should meet the following formula:

$${T}_{OFF} = K \cdot \frac{{V}_{IN} - {V}_{O}}{{V}_{IN}} \qquad ( 1 )$$

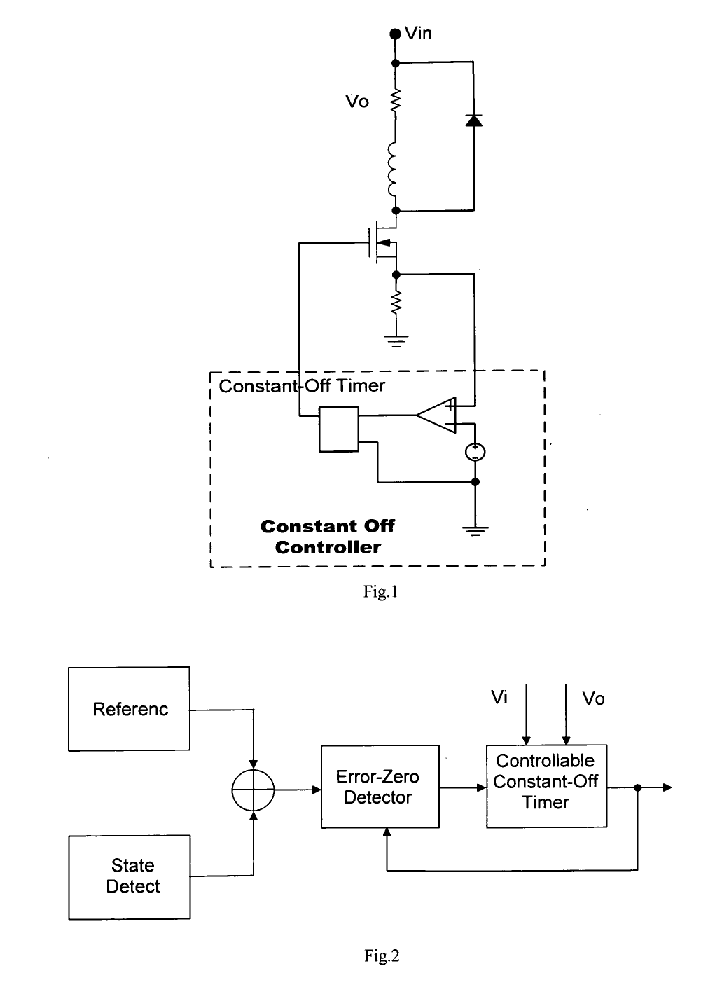

FIG. 2 shows the controllable constant off timer is controlled with the input and output voltages of the switching converter.

The benefit of using “High Accuracy Constant-Off Average Output Current Control” technology is that it is the simplest and lowest cost to implement the average current control of step-down switching converter.

What is claimed is:

1. High accuracy constant-off average output current control scheme comprising:
The reference block generating preset reference and converting the reference signal into a suitable format; and
The state detecting block, detecting the state variables of switching power converter and the detected signals converting into the same signal format as one of output from reference block; and
The error-zero detector detecting the error between the outputs from reference block and state detected block and triggering the constant off timer as the error cross over zero; and
The constant off timer, the constant off time dependent on the input and output voltages of the switching converter.

2. High accuracy constant-off average output current control scheme claim 1, wherein the error-zero detector can be simple as comprising of a basic operation and be implemented with several operation functions.

3. High accuracy constant-off average output current control scheme claim 1, wherein the state detect block can be simple as a sense resistor and be implemented with several operation functions.

4. High accuracy constant-off average output current control scheme claim 1, wherein the reference block generates preset reference and converts the reference signal into a suitable format

5. High accuracy constant-off average output current control scheme claim 1, wherein the constant off timer, the constant off time is dependent on the input and output voltages of the switching converter.
